(19) United States
(12) Patent Application Publication
(10) Pub. No.: US 2025/0276557 A1
(43) Pub. Date: Sep. 4, 2025

(54) AIR CONDITIONER FOR VEHICLE

(71) Applicant: Hanon Systems, Daejeon (KR)

(72) Inventors: Hwan Kyu CHO, Daejeon (KR); Jae Woo KO, Daejeon (KR); Ki Man JEON, Daejeon (KR)

(73) Assignee: Hanon Systems, Daejeon (KR)

(21) Appl. No.: 19/063,109

(22) Filed: Feb. 25, 2025

(30) Foreign Application Priority Data
Feb. 29, 2024 (KR) 10-2024-0029702
Dec. 23, 2024 (KR) 10-2024-0193569

(51) Int. Cl. B60H 1/00

(52) U.S. Cl. CPC B60H 1/00021; B60H 1/00835; B60H 2001/00092; B60H 2001/00114

(57) ABSTRACT

Disclosed is an air conditioner for a vehicle. The air conditioner for a vehicle includes: an air conditioning case including an air inflow port for introducing air, air discharge ports for discharging air into the interior, and an internal air passage formed therein; a cooling heat exchanger and a heating heat exchanger sequentially provided in the air passage of the air conditioning case in an air flow direction; and doors for adjusting the opening degree of the air passage in the air conditioning case via rotation, wherein an airflow control door is arranged downstream of a blower in the air flow direction, and is positioned adjacent to a cutoff region of a blower scroll case.

### BACKGROUND OF THE INVENTION

### Field of the Invention

The present invention relates to an air conditioner for a vehicle, and more specifically, to an air conditioner for a vehicle which includes an airflow control door positioned at a rear end of a console blower for blowing conditioned air to rear seats of the vehicle.

### Background Art

In general, an air conditioner for a vehicle is a vehicle interior part that is installed for the purpose of cooling or heating the interior of the vehicle in the summer or winter or securing a driver's front and rear view by removing the frost from the windshield during the rainy or winter season. The air conditioner is usually equipped with a heating system and a cooling system to selectively introduce the indoor air or the outdoor air, heat or cool the air, and blow the heated or cooled air to the interior of the vehicle, thereby cooling, heating, or ventilating the interior of the vehicle.

Korean Patent No. 1484718 (published on Jan. 14, 2015) discloses an air conditioner for a vehicle, which adjusts rear airflow by controlling the positions of a rear temperature door, an rear auxiliary temperature door, and a rear on-off door. Referring to FIG. 1, the air conditioner for a vehicle includes an air conditioning case 10, an evaporator 20, a heater core 30, and a front temperature door 51, and front mode doors.

The air conditioning case 10 includes an air inflow port 11, air discharge ports, and an internal air passage formed therein. An air blower is connected to the air inflow port 11 to selectively introduce inside air or outside air into the internal air passage within the air conditioning case 10. The air discharge ports include a defrost vent 12, a front face vent 13, a front floor vent 14, a rear face vent 15, and a rear floor vent 16. The internal air passages of the air conditioning case 10 include a front cooling passage P1, a heating passage P2, and a rear cooling passage P3.

The evaporator 20, serving as a cooling heat exchanger, cools the air passing through the evaporator 20, and the heater core 30, functioning as a heating heat exchanger, heats the air passing through the heater core. The heater core 30 is positioned downstream of the evaporator 20, namely the heating passage P2, in an air flow direction. An electric heater 40, such as a PTC heater, may be installed within the heating passage P2. The front temperature door 51 is positioned between the evaporator 20 and the heater core 30 to control the opening degree of the heating passage P2 passing through the heater core 30 and the opening degrees of the cooling passages P1 and P3 bypassing the heater core 30. Moreover, the front mode doors include a defrost door 53, a vent door 54, and a floor door 55.

The rear air passage includes a rear cooling passage P3 that the air passing through the evaporator 20 bypasses the heater core 30 and a heating passage that the air passing through the evaporator 20 passes through the heater core 30. The heating passage of the rear air passage is shared with the heating passage P2 of the front air passage. That is, a portion of the air flowing through the heating passage P2 after passing through the heater core 30 moves upward and is discharged through at least one of the defrost vent 12, the front face vent 13, and the front floor vent 14. The remaining air moves downward and is discharged through at least one of the rear face vent 15 and the rear floor vent 16. A rear mode door 58 is provided in the rear air passage to adjust the opening degree of the rear face vent 15 and the opening degree of the rear floor vent 16.

A rear temperature door 52, a rear auxiliary temperature door 56, and a rear on-off door 57 are included within the air conditioning case 10. The rear temperature door 52 is located between the evaporator 20 and the heater core 30 to adjust the opening degree of the passage directing to the heating passage P2 and the opening degree of the passage directing to the rear cooling passage P3. The rear auxiliary temperature door 56 is positioned downstream of the heater core 30 in the air flow direction to adjust the opening degree of the air passage leading to the rear air discharge port. The rear on-off door 57 adjusts the opening degree of the rear cooling passage P3.

Meanwhile, a console blower, which acts as an auxiliary blower to efficiently deliver air to the rear seats (console) of the vehicle, may be further provided at the rear air discharge port. One side of the console blower is connected to the rear air discharge port, and includes a blower wheel rotated by a blower motor. An airflow control door is provided downstream of the blower wheel in the air flow direction to regulate the amount of airflow.

However, the conventional air conditioner for the vehicle has a disadvantage in that control value intervals of the airflow control door get narrower as the airflow decreases at blower stage settings. In case of blower stage 1 to blower stage 3, the conventional air conditioner for the vehicle cannot ensure controllability since the drive voltage control values of the door by each stage are at the actuator operation tolerance level.

### PATENT LITERATURE

### Patent Documents

Patent Document 1: Korean Patent No. 1484718 (Jan. 14, 2015)

### SUMMARY OF THE INVENTION

Accordingly, the present invention has been made to solve the above-mentioned problems occurring in the prior arts, and it is an objective of the present invention to provide an air conditioner for a vehicle which, when an airflow control door is closed at a discharge port of a rear blower, can maintain a uniform gap between a door and a case by forming a structure within an optimized closing rate of the airflow control door not to interrupt a main streamline of air.

To accomplish the above object, according to the present invention, there is provided an air conditioner for a vehicle including: an air conditioning case including an air inflow port for introducing air, air discharge ports for discharging air into the interior, and an internal air passage formed therein; a cooling heat exchanger and a heating heat exchanger sequentially provided in the air passage of the air conditioning case in an air flow direction; and doors for adjusting the opening degree of the air passage in the air conditioning case via rotation, wherein an airflow control door is arranged downstream of a blower in the air flow direction, and is positioned adjacent to a cutoff region of a blower scroll case.

The air conditioner for the vehicle further includes an on-off door configured to open and close the air passage upstream of the blower in the air flow direction.

One on-off door is provided, and two airflow control doors are respectively positioned on the left side and the right side.

The airflow control door is arranged at an 50% opened position such that a door extension line is connected to a center shaft of the blower.

The center shaft of the blower is located within an operation region extension line of the airflow control door.

The airflow control door includes a gap-maintaining part configured to maintain a uniform gap between the end of the door and the air conditioning case in a range from a fully closed position to a partially opened position within a door operation region.

The airflow control door is arranged in parallel to the air flow direction at a fully opened position of the airflow control door.

The gap-maintaining part is formed such that a rotation angle of the airflow control door is 50%.

The air discharge port includes a rear air discharge port for discharging air to the rear seats of the vehicle, the blower is connected to the rear air discharge port to deliver air to the rear seats, and the airflow control door is provided downstream of the blower in the air flow direction.

The air conditioning case includes a scroll case on the blower side where a blower wheel is installed, and the airflow control door is of a center pivot type including a rotational shaft rotatably mounted on the scroll case and plates extending radially on both sides of the rotational shaft.

The gap-maintaining part is formed on the scroll case facing both ends of the plates of the airflow control door to maintain a uniform gap between the ends of the plates and the scroll case.

The gap-maintaining part and the airflow control door are arranged adjacent to the blower wheel of the blower.

The gap-maintaining part protrudes from the inner wall surface of the scroll case and is streamlined to maintain the uniform gap between the scroll case and the end of the airflow control door.

Both sides of the airflow control door are symmetrical based on the rotational shaft, and the gap-maintaining part is formed symmetrically on the scroll case facing both ends of the plates of the airflow control door relative to the rotational shaft.

The gap between the end of the door and the air conditioning case within the operation region of the airflow control door, from a 25% to 75% opened position to the fully closed position, is 3 mm to 5 mm.

The airflow control door rotates so that, based on the rotational shaft, an outer portion of the scroll case is opened in the same direction as the air flow direction and a cutoff side of the scroll case is opened in the opposite direction to the air flow direction.

The air conditioning case includes a scroll case on the blower side where a blower wheel is installed, the airflow control door is of a center pivot type including a rotational shaft rotatably mounted on the scroll case and plates extending radially on both sides of the rotational shaft, and a stopper is provided on the scroll case to restrict the opening of the airflow control door.

The stopper allows, based on the rotational shaft of the airflow control door, the door corresponding to the outer portion of the scroll case to be opened in the same direction as the air flow direction and the door corresponding to the inner portion of the scroll case to be opened in the opposite direction to the air flow direction.

The inner portion is near to the cutoff region of the scroll case.

As described above, the air conditioner for a vehicle according to the present invention can increase the airflow reduction level by reducing the opening rate only when the airflow control door is in the closed state without interrupting the main streamline of air in the fully opened state of the airflow control door, thereby enhancing controllability.

Furthermore, the air conditioner for a vehicle according to the present invention is configured such that, according to the airflow, the door corresponding to the outer portion of the scroll case, where static pressure is higher, is opened in the same direction as the airflow but the door corresponding to the inner portion (near the cutoff region) of the scroll case, where static pressure is relatively lower, is opened in the opposite direction to the airflow.

### BRIEF DESCRIPTION OF THE DRAWINGS

FIG. 1 is a side cross-sectional view illustrating a conventional air conditioner for a vehicle.

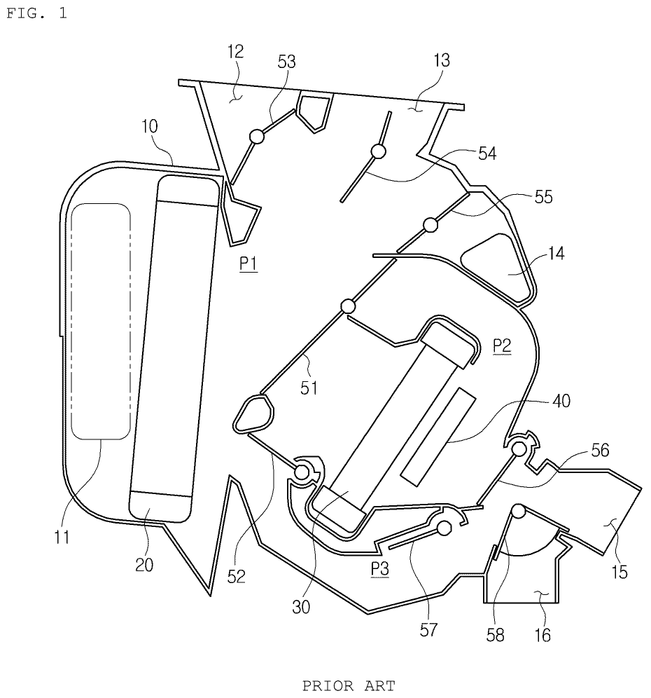

FIG. 2 is a perspective view illustrating an air conditioner for a vehicle according to a first embodiment of the present invention.

FIG. 3 is a side cross-sectional view illustrating the air conditioner for the vehicle according to the first embodiment of the present invention.

FIG. 4 is an enlarged side cross-sectional view illustrating an airflow control door of the air conditioner for the vehicle according to the first embodiment of the present invention.

FIG. 5 is a modified example of FIG. 4, illustrating an embodiment in which a gap-maintaining part is formed from 25% position of the rotation angle of the airflow control door.

FIG. 6 is another modified example of FIG. 4, illustrating an embodiment in which a gap-maintaining part is formed from 75% position of the rotation angle of the airflow control door.

FIG. 7 is a diagram illustrating an airflow when the airflow control door of the air conditioner for the vehicle according to the first embodiment of the present invention is fully opened.

FIG. 8 is a diagram illustrating the airflow when the airflow control door of the air conditioner for the vehicle according to the first embodiment of the present invention is 50% closed.

FIG. 9 is an experimental diagram illustrating the airflow of a blower of the air conditioner for the vehicle according to the first embodiment of the present invention.

FIG. 10 is a graph showing the relationship between door voltage and airflow of the airflow control door of the air conditioner for the vehicle according to the first embodiment of the present invention.

FIG. 11 is a side cross-sectional view illustrating the air conditioner for the vehicle according to a second embodiment of the present invention.

FIG. 12 is a diagram illustrating a state in which an airflow control door of the air conditioner for the vehicle according to the second embodiment of the present invention is 50% opened.

FIG. 13 is a diagram illustrating a state in which an airflow control door of the air conditioner for the vehicle according to the second embodiment of the present invention is 100% opened.

FIGS. 14 and 15 are perspective views illustrating the interior of a scroll case of the air conditioner for the vehicle according to the second embodiment of the present invention.

### DETAILED DESCRIPTION OF THE PREFERRED EMBODIMENT

Hereinafter, referring to the drawings, the technical configuration of an air conditioner for a vehicle will be described in detail.

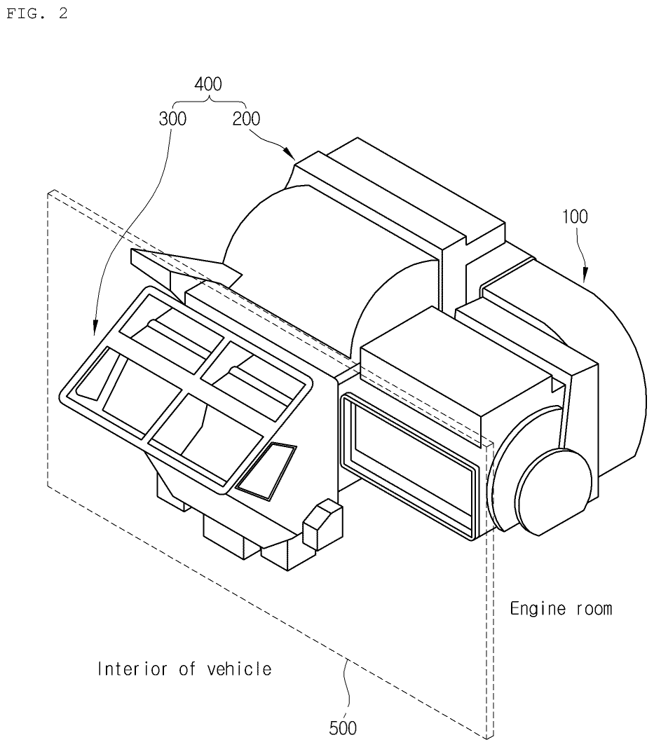

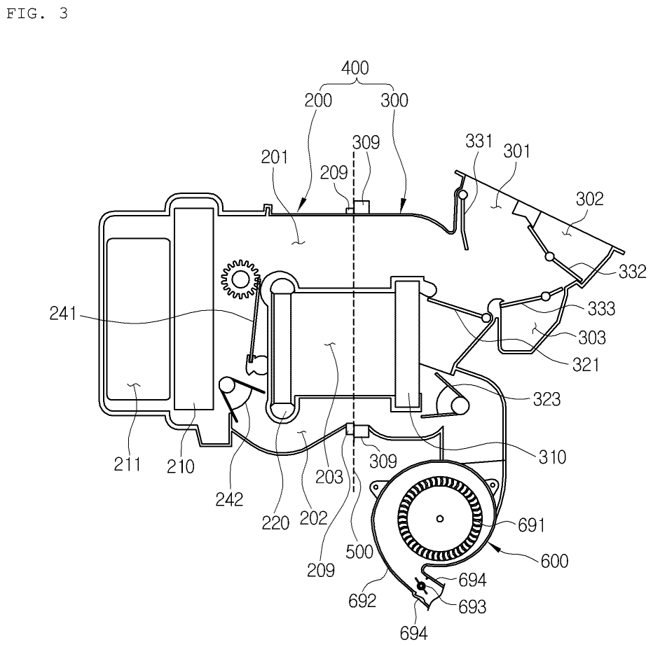

Referring to FIGS. 2 to 4, an air conditioner for a vehicle according to a first embodiment of the present invention, which is an air conditioner employing a heat pump system installed in an electric vehicle, includes a blower unit 100 and an air conditioning unit 400. The air conditioning unit 400 includes an air conditioning case, a cooling heat exchanger, and a heating heat exchanger.

The air conditioning case includes an air inflow port 211 for introducing air, air discharge ports for discharging air into the interior, and an internal air passage formed therein. The air conditioning unit 400 includes a heat exchanger module 200 positioned in a vehicle engine room and a distribution module 300 positioned in the interior of the vehicle. The blower unit 100 includes a main blower. The main blower is installed at the air inflow port 211 of the air conditioning case to supply air into the air conditioning case.

The distribution module 300 and the heat exchanger module 200 form the air conditioning unit 400 by being coupled at both sides of a dashboard panel 500 in a back-and-forth direction of the vehicle. The dashboard panel 500 includes a through-hole for securing the distribution module 300 and the heat exchanger module 200 in the back-and-forth direction of the vehicle. A fastening part 209 is provided at the end of the heat exchanger module 200 which is coupled with the distribution module 300, and the distribution module 300 also has a fastening part 309 corresponding to the fastening part 209 of the heat exchanger module 200.

The cooling heat exchanger and the heating heat exchanger are sequentially arranged in the air passage of the air conditioning case in an air flow direction to exchange heat with the air passing through them. The cooling heat exchanger is configured as an evaporator 210 which exchanges heat with refrigerant to cool the air. The heating heat exchanger is configured as an indoor heat exchanger 220, which is positioned downstream of the evaporator 210 in the air flow direction.

That is, a compressor, the indoor heat exchanger 220, an outdoor heat exchanger, an expansion valve, and the evaporator 210 are sequentially installed in a refrigerant line. Furthermore, the indoor heat exchanger 220 dissipates heat by exchanging heat between refrigerant of high-temperature and high-pressure discharged from the compressor and the air of the air conditioning case, thereby heating the air. The refrigerant throttled by the expansion valve exchanges heat with the air in the evaporator 210 to cool the air.

Additionally, the distribution module 300 further includes an electric heater 310. The electric heater 310 is positioned downstream of the indoor heat exchanger 220 in the air flow direction. The electric heater 310 is installed at a similar height to the rear side of the indoor heat exchanger 220 in the vertical direction and is arranged parallel to the indoor heat exchanger 220 in the vertical direction. The electric heater 310 is a positive temperature coefficient (PTC) heater, and functions as a supplemental heating heat exchanger, which generates heat when power is applied, thereby heating the air passing through the electric heater.

The air passage in the air conditioning case 400 forms a warm air passage 203 in the middle part in the vertical direction, and includes cold air passages 201 and 202 formed above and below the warm air passage 203, respectively. Meanwhile, a main temperature door is provided between the evaporator 210 and the indoor heat exchanger 220, and an auxiliary temperature door is provided downstream of the indoor heat exchanger 220 in the air flow direction. The main temperature door includes a front main temperature door 241 and a rear main temperature door 242, and the auxiliary temperature door includes a front auxiliary temperature door 321 and a rear auxiliary temperature door 323.

The air discharge ports of the air conditioning case are divided into front air discharge ports and rear air discharge ports. The front air discharge ports include a defrost vent 301, a face vent 302, and a floor vent 303. The rear air discharge ports are configured to discharge air into the rear seats of the vehicle and may include a console vent and a rear floor vent. The air conditioning case includes doors. The doors adjust the opening degree of the air passage in the air conditioning case via rotation. The doors include mode doors. The mode doors include a defrost door 331 for adjusting the opening degree of the defrost vent 301, a vent door 332 for adjusting the opening degree of the face vent 302, and a floor door 333 for adjusting the opening degree of the floor vent 303.

A blower 600 is further provided downstream of the rear air discharge port in the air flow direction to facilitate smooth air delivery to the rear seats of the vehicle. The blower 600 is installed at the rear air discharge port to deliver air to the rear seats and includes a blower wheel 691. The air conditioning case includes a scroll case 692. The scroll case 692 is provided on the blower 600 on which the blower wheel 691 is installed.

Meanwhile, the door includes an airflow control door 693. The airflow control door 693 is positioned downstream of the blower 600 in the air flow direction. So, after the air conditioned through the air conditioning unit 400 passes through the rear air discharge port and goes through the blower wheel 691 of the blower 600, the airflow control door 693 controls the amount of air discharged toward the rear seats of the vehicle. The airflow control door 693 is formed of a center pivot type. That is, the airflow control door 693 includes a rotational shaft 695 and plates 696.

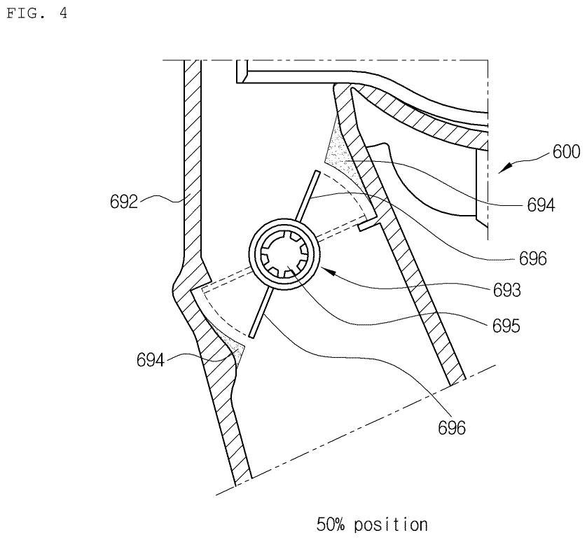

The rotational shaft 695 is rotatably mounted on the scroll case 692 and is rotatably positioned at a certain distance from the outer side of the scroll case 692. In this case, the outer side of the scroll case 692 refers to the outer side of a scroll part where air flows along the periphery of the blower wheel 691, as shown on the left side in FIG. 4, and the inner side of the scroll case 692 refers to the inner side of the scroll part where air flows along the periphery of the blower wheel 691, namely, near to the cut-off, as shown on the right side in FIG. 4. The plates 696 extend radially on both sides of the rotational shaft 695.

Specifically, the air conditioner for the vehicle according to one embodiment of the present invention includes a gap-maintaining part 694. The gap-maintaining part 694 maintains a uniform gap (d) between the end of the airflow control door 693 and the air conditioning case within a door operation range of the airflow control door 693, from 25% to 75% opened state to the fully closed state.

The gap-maintaining part 694 is formed on the inner and outer inner wall surfaces of the scroll case 692. That is, the gap-maintaining part 694 is positioned on the inner wall surface of the scroll case 692 facing both ends of the plates 696 of the airflow control door 693. The gap-maintaining part 694 keeps a uniform gap (d) between the ends of the plates 696 and the scroll case 692 in a range from a fully closed position to a partially opened position within a door operation region of the airflow control door 693. Preferably, the gap-maintaining part 694 maintains the uniform gap (d) between the ends of the plates 696 and the scroll case 692 in the range from a 25% to 75% opened position to the fully closed position within the door operation region of the airflow control door 693. Furthermore, the gap-maintaining part 694 and the airflow control door 693 are arranged adjacent to the blower wheel 691 of the blower 600.

The strong wind blown from the blower wheel 691 is regulated in airflow by the airflow control door 693 located immediately downstream of the blower wheel 691. As a result, the airflow control door 693 experiences relatively high air pressure, inevitably reducing controllability. The gap-maintaining part 694 is positioned at the rear end of the blower wheel 691, enhancing the controllability of the airflow control door 693.

The gap-maintaining part 694 protrudes from the inner wall surface of the scroll case 692. The gap-maintaining part 694 features a streamlined surface facing the airflow control door 693 to maintain a uniform gap between the ends of the plates 696 and the scroll case. The streamlined surface of the gap-maintaining part 694 extends to correspond to the rotational arc of the airflow control door 693, such that the gap between the facing surfaces of the ends of the plates 696 and the gap-maintaining part 694 is maintained uniformly in the range from the 25% to 75% opened position to the fully closed position within the door operation region of the airflow control door 693.

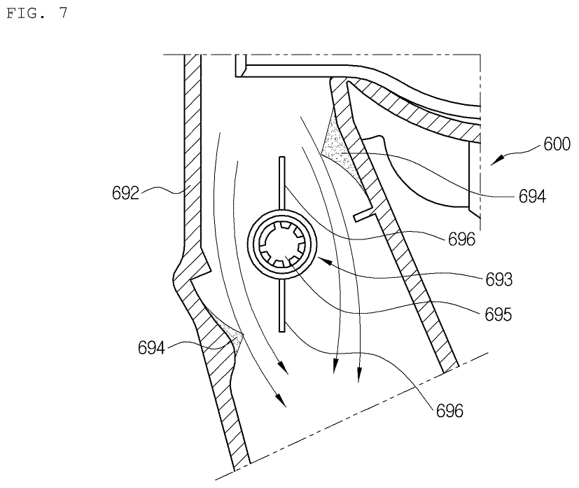

The gap-maintaining part 694 is formed within the rotation angle of the airflow control door 693, from the 25% to 75% position to the fully closed position. That is, a portion or the entire of the 25% to 75% range of the rotation angle of the airflow control door 693 becomes a starting point of the gap-maintaining part. In this case, 0% represents the fully closed state of the airflow control door 693, and 100% represents the fully opened state as illustrated in FIG. 7.

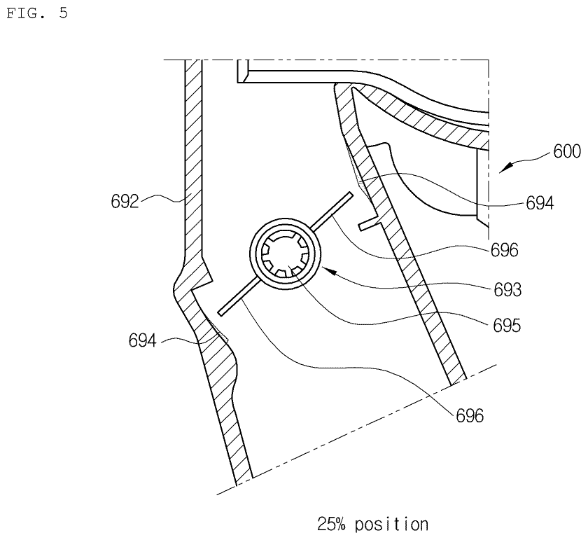

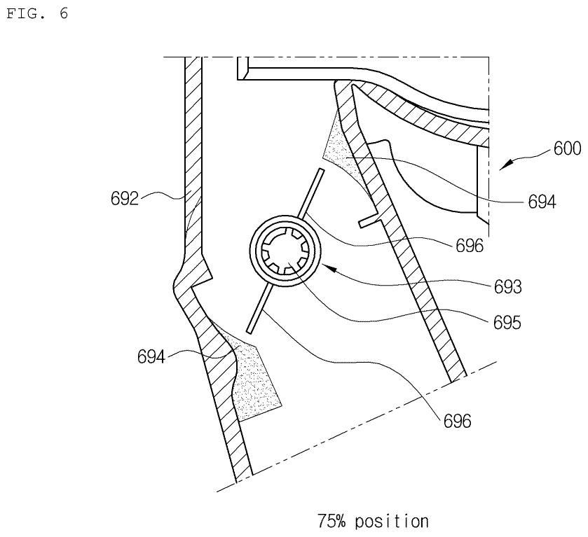

Referring further to FIG. 5, the gap-maintaining part 694 can maintain the uniform gap (d) between the end of the airflow control door 693 and the air conditioning case till the airflow control door 693 is fully closed from the 25% closed state. Alternatively, referring to FIG. 6, the gap-maintaining part 694 can maintain the uniform gap (d) between the end of the airflow control door 693 and the air conditioning case till the airflow control door 693 is fully closed from the 75% closed state. As described above, the gap-maintaining part 694 can maintain the uniform gap (d) between the end of the airflow control door 693 and the air conditioning case till the airflow control door 693 is fully closed from the 25% to 75% closed state.

Preferably, the gap-maintaining part 694 is formed within the rotation angle of the airflow control door 693, from a 40% to 60% closed position to the fully closed position. That is, the gap-maintaining part 694 can maintain the uniform gap (d) between the end of the airflow control door 693 and the air conditioning case till the airflow control door 693 is fully closed from the 40% closed state. Alternatively, the gap-maintaining part 694 can maintain the uniform gap (d) between the end of the airflow control door 693 and the air conditioning case till the airflow control door 693 is fully closed from the 60% closed state. As described above, the gap-maintaining part 694 can maintain the uniform gap (d) between the end of the airflow control door 693 and the air conditioning case till the airflow control door 693 is fully closed from the 40% to 60% closed state.

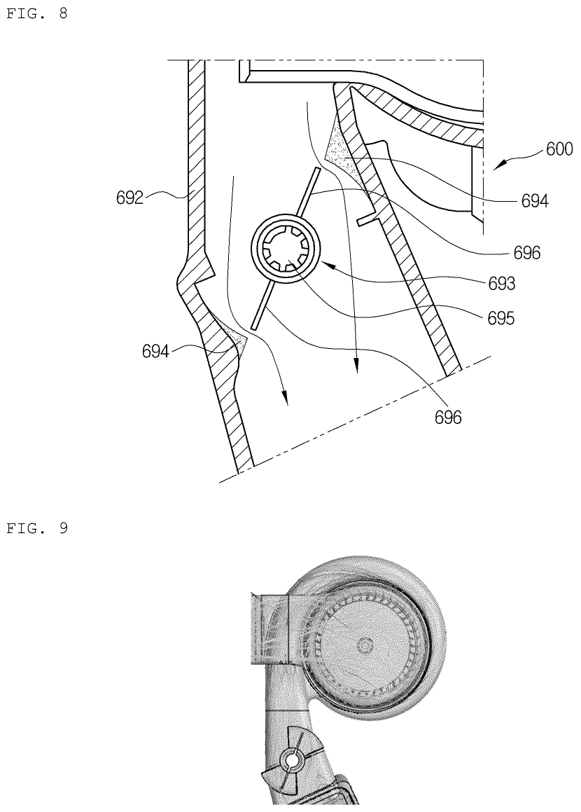

Most preferably, as illustrated in FIG. 8, the gap-maintaining part 694 is formed such that the rotation angle of the airflow control door 693 reaches 50%. In other words, the gap-maintaining part 694 maintains the uniform gap (d) between the end of the airflow control door 693 and the air conditioning case till the airflow control door 693 is fully closed from the 50% closed state.

Meanwhile, both sides of the airflow control door 693 are symmetrical based on the rotational shaft 695. Additionally, the gap-maintaining part 694 is formed symmetrically on the inner and outer sides of the scroll case 692 relative to the rotational shaft 695 of the airflow control door 693. That is, the gap-maintaining part 694 is formed symmetrically on the scroll case 692 facing both ends of the plates 696 of the airflow control door 693 relative to the rotational shaft 695.

The airflow control door 693 rotates so that the outer portion of the scroll case 692, where air is concentrated, is opened in the same direction as the air flow direction and the cutoff side (inner portion) of the scroll case 692, where air is relatively less concentrated, is opened in the opposite direction to the air flow direction. Due to the structure of the blower 600, since air tends to be directed toward the outer portion of the scroll case 692, the rotational direction of the airflow control door 693 is optimized, minimizing airflow resistance.

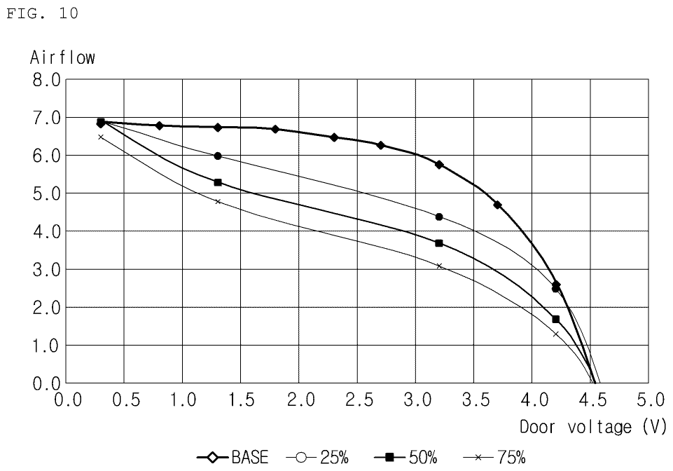

In the conventional structures without the gap-maintaining part, when the airflow control door is installed near the blower for airflow control, airflow is concentrated toward the outer portion of the scroll case 692, so even if the airflow control door 693 is closed by the increased air pressure at the scroll discharge part, the airflow reduction is insignificant. As illustrated in FIG. 9, the present invention includes the gap-maintaining part 694, partially covering the outer portion of the scroll case 692, thus enabling precise airflow adjustment.

In this instance, if the airflow control door 693 is configured not as the center pivot type but as an end pivot type having plates formed only on one side of the rotational shaft, the airflow change is insignificant when the airflow control door 693 is closed at an arbitrary rotation angle (e.g., 50%). To overcome the problem, when the gap-maintaining part 694 which is a structure for maintains a uniform gap as in the present invention, is configured, another problem occurs in which the maximum airflow is significantly reduced.

Thus, the airflow control door 693 is configured as the center pivot type, and sealing surfaces for the airflow control door 693 are formed on both sides of the scroll case 692. Additionally, the gap-maintaining part 694, which maintains the uniform gap of the rotation radius of the airflow control door 693, is formed at the rear side of the sealing surface up to a predetermined rotation angle (preferably 50%) closed position. As a result, when the airflow control door 693 is 50% closed, the airflow reduction level is equivalent to the airflow reduction level achieved in the conventional structure when the airflow control door is 75% closed.

In this case, the gap between the end of the airflow control door 693 and the air conditioning case within the door operation region of the airflow control door 693, from the 25% to 75% opened position to the fully closed position, is preferably 3 mm to 5 mm. More preferably, the minimum gap between the end of the airflow control door 693 and the air conditioning case within the door operation region of the airflow control door 693, from the 25% to 75% opened position to the fully closed position, is 4 mm.

If the minimum gap between the airflow control door and the air conditioning case is less than 4 mm, a whistle noise may occur as air passes through the gap between the end of the airflow control door 693 and the air conditioning case. If the minimum gap between the airflow control door and the air conditioning case exceeds 4 mm, the gap-maintaining part fails to function effectively, failing to secure performance.

The air conditioner for the vehicle according to the first embodiment of the present invention forms the gap-maintaining part 694 to ensure the uniform gap between the rotational radius of the airflow control door 693 and the air conditioning case up to approximately a 50% opened position of the airflow control door 693. The gap-maintaining part 694 may be fabricated as a separate structure to be attached to the inner wall of the air conditioning case (scroll case), but it is preferable to integrally form the gap-maintaining part during the molding of the scroll case.

The present invention maintains equivalent air conditioning performance and does not cause the reduction of airflow compared to the conventional structures without the gap-maintaining part when the airflow control door 693 is fully opened. In addition, when the airflow control door 693 is controlled in the closing direction from the 50% closed position to the fully closed position, the airflow reduction level increases. Therefore, the present invention can ensure the maximum air conditioning performance and improve controllability.

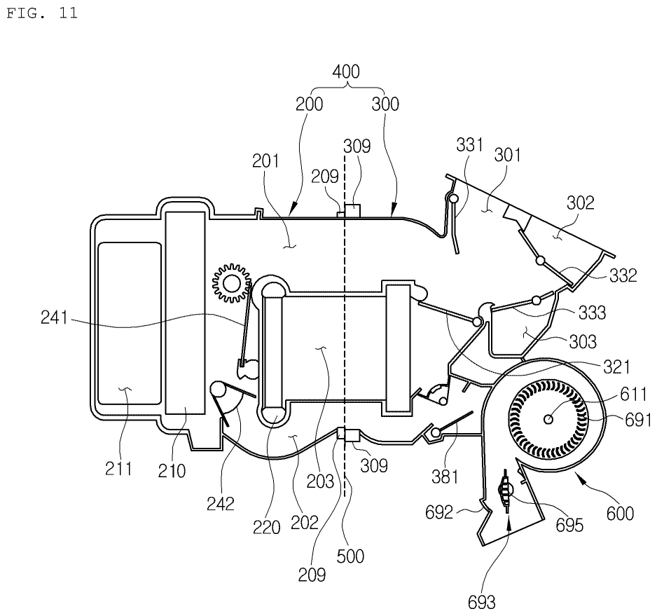

Referring further to FIG. 10, when the gap-maintaining part 694 is applied up to the 25% to 75% position of the airflow control door 693, it enhances controllability but reduces full-open performance when the gap-maintaining part 694 is applied up to the 75% position. In FIG. 10, the vertical axis represents airflow, and the horizontal axis represents the driving voltage of the airflow control door 693.

Therefore, it is preferable to apply the gap-maintaining part 694 within the range of 40% to 60% position of the airflow control door 693, and more preferably, the gap-maintaining part 694 is applied up to 50% position of the airflow control door 693. As described above, in the fully opened state, the air conditioner for a vehicle according to the present invention can increase the airflow reduction level by reducing the opening rate only when the airflow control door is in the closed state without interrupting the main streamline of air, thereby enhancing controllability.

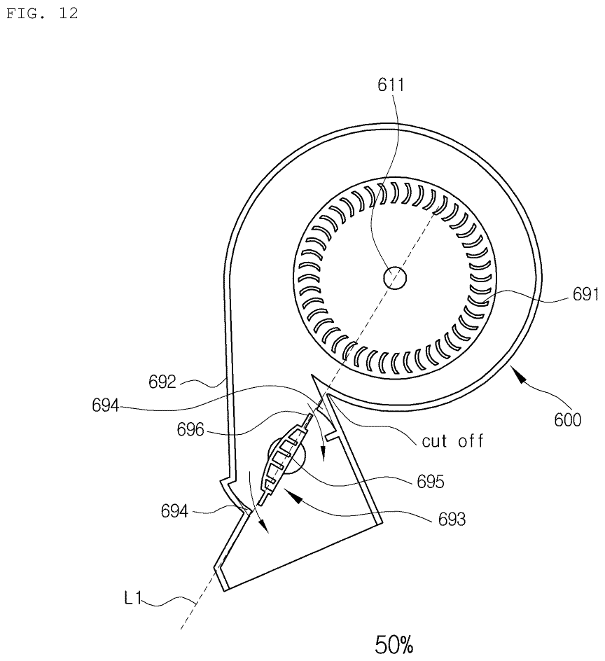

Meanwhile, referring to FIGS. 11 to 15, the air conditioner for the vehicle according to the first embodiment includes the blower unit 100 and the air conditioning unit 400. In the second embodiment, only the differences compared to the first embodiment will be described.

The air conditioning case of the air conditioning unit 400 further includes an on-off door 381. The on-off door 381 is positioned upstream of the blower 600 in the air flow direction and opens and closes the air passage directing to the rear air discharge port. The airflow control door 693 is positioned downstream of the blower 600 in the air flow direction. The airflow control door 693 is arranged adjacent to the cutoff region of the scroll case 692.

In this case, one on-off door 381 is provided, and two airflow control doors 693 are respectively positioned on the left side and the right side in the vehicle width direction. If it is desired to increase the airflow to the left side of the vehicle rear, the on-off door 381 can be fully opened, and the left airflow control door 693 can be opened wider than the right airflow control door 693, enabling independent left-right air conditioning control for the rear seats of the vehicle. As described above, the on-off door 381, the blower 600, and the airflow control doors 693 allow for independent left-right air conditioning control for the rear seats of the vehicle.

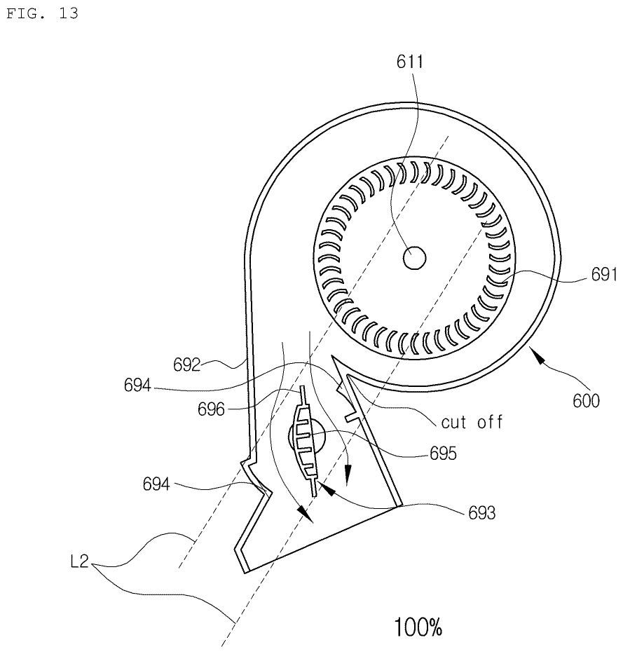

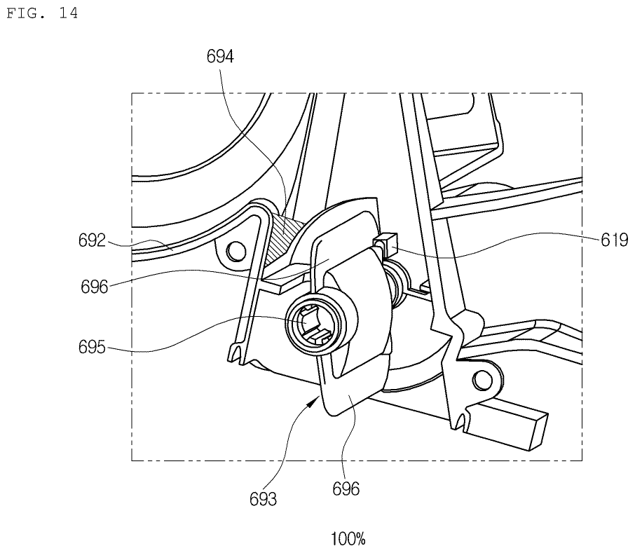

As illustrated in FIG. 12, the airflow control door 693 is arranged at the 50% opened position such that a door extension line L1 is connected to a center shaft 611 of the blower 600. Additionally, as illustrated in FIG. 13, the center shaft 611 of the blower 600 is located within an operation region extension line L2 of the airflow control door 693. At the fully opened position of the airflow control door 693, the airflow control door 693 is arranged in parallel to the air flow direction.

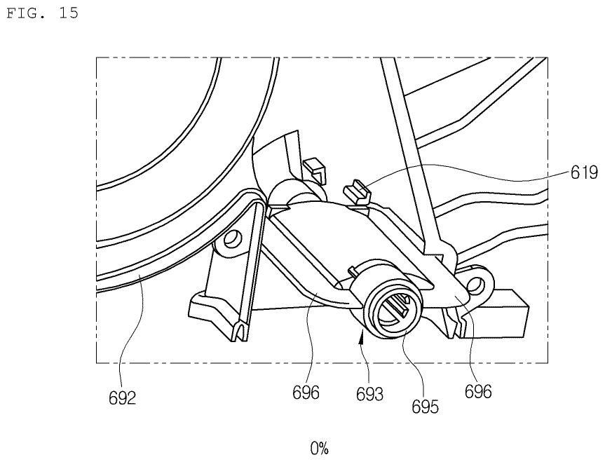

As illustrated in FIGS. 14 and 15, the scroll case 692 includes a stopper 619. The stopper 619 restricts the opening of the airflow control door 693. That is, the stopper 619 allows the door corresponding to the outer portion of the scroll case 692 based on the rotational shaft 695 of the airflow control door 693 to be opened in the same direction as the air flow direction and the door corresponding to the inner portion to be opened in the opposite direction to the air flow direction. In this case, the inner portion is near to the cutoff region of the scroll case 692.

That is, the air conditioner for a vehicle according to the present invention is configured such that, according to the airflow, the door corresponding to the outer portion of the scroll case, where static pressure is higher, is opened in the same direction as the airflow but the door corresponding to the inner portion (near the cutoff region), where static pressure is relatively lower, is opened in the opposite direction to the airflow.

The air conditioner for a vehicle according to the present invention has been described with reference to the embodiments illustrated in the drawings, but the embodiments are merely examples. It should be apparent that modifications and variations can be made by persons skilled without deviating from the spirit or scope of the present invention. Therefore, the true scope of technical protection should be defined by the spirit of the appended claims.

What is claimed is:

1. An air conditioner for a vehicle comprising:
an air conditioning case including an air inflow port for introducing air, air discharge ports for discharging air into the interior, and an internal air passage formed therein;
a cooling heat exchanger and a heating heat exchanger sequentially provided in the air passage of the air conditioning case in an air flow direction; and
doors for adjusting the opening degree of the air passage in the air conditioning case via rotation,
wherein an airflow control door is arranged downstream of a blower in the air flow direction, and is positioned adjacent to a cutoff region of a blower scroll case.

2. The air conditioner according to claim 1, further comprising:
an on-off door configured to open and close the air passage upstream of the blower in the air flow direction.

3. The air conditioner according to claim 2, wherein one on-off door is provided, and two airflow control doors are respectively positioned on the left side and the right side.

4. The air conditioner according to claim 1, wherein the airflow control door is arranged at an 50% opened position such that a door extension line is connected to a center shaft of the blower.

5. The air conditioner according to claim 1, wherein the center shaft of the blower is located within an operation region extension line of the airflow control door.

6. The air conditioner according to claim 1, wherein the airflow control door includes a gap-maintaining part configured to maintain a uniform gap between the end of the door and the air conditioning case in a range from a fully closed position to a partially opened position within a door operation region.

7. The air conditioner according to claim 1, wherein the airflow control door is arranged in parallel to the air flow direction at a fully opened position of the airflow control door.

8. The air conditioner according to claim 6, wherein the gap-maintaining part is formed such that a rotation angle of the airflow control door is 50%.

9. The air conditioner according to claim 1, wherein the air discharge port includes a rear air discharge port for discharging air to the rear seats of the vehicle,
wherein the blower is connected to the rear air discharge port to deliver air to the rear seats, and
wherein the airflow control door is provided downstream of the blower in the air flow direction.

10. The air conditioner according to claim 9, wherein the air conditioning case includes a scroll case on the blower side where a blower wheel is installed, and
wherein the airflow control door is of a center pivot type including a rotational shaft rotatably mounted on the scroll case and plates extending radially on both sides of the rotational shaft.

11. The air conditioner according to claim 10, wherein the airflow control door includes a gap-maintaining part configured to maintain a uniform gap between the end of the door and the air conditioning case in a range from a fully closed position to a partially opened position within a door operation region, and
wherein the gap-maintaining part is formed on the scroll case facing both ends of the plates of the airflow control door to maintain a uniform gap between the ends of the plates and the scroll case.

12. The air conditioner according to claim 11, wherein the gap-maintaining part and the airflow control door are arranged adjacent to the blower wheel of the blower.

13. The air conditioner according to claim 11, wherein the gap-maintaining part protrudes from the inner wall surface of the scroll case and is streamlined to maintain the uniform gap between the scroll case and the end of the airflow control door.

14. The air conditioner according to claim 11, wherein both sides of the airflow control door are symmetrical based on the rotational shaft, and
wherein the gap-maintaining part is formed symmetrically on the scroll case facing both ends of the plates of the airflow control door relative to the rotational shaft.

15. The air conditioner according to claim 6, wherein the gap between the end of the door and the air conditioning case within the operation region of the airflow control door, from a 25% to 75% opened position to the fully closed position, is 3 mm to 5 mm.

16. The air conditioner according to claim 10, wherein the airflow control door rotates so that, based on the rotational shaft, an outer portion of the scroll case is opened in the same direction as the air flow direction and a cutoff side of the scroll case is opened in the opposite direction to the air flow direction.

17. The air conditioner according to claim 1, wherein the air conditioning case includes a scroll case on the blower side where a blower wheel is installed,
wherein the airflow control door is of a center pivot type including a rotational shaft rotatably mounted on the scroll case and plates extending radially on both sides of the rotational shaft, and
wherein a stopper is provided on the scroll case to restrict the opening of the airflow control door.

18. The air conditioner according to claim 17, wherein the stopper allows, based on the rotational shaft of the airflow control door, the door corresponding to the outer portion of the scroll case to be opened in the same direction as the air flow direction and the door corresponding to the inner portion of the scroll case to be opened in the opposite direction to the air flow direction.

19. The air conditioner according to claim 18, wherein the inner portion is near to the cutoff region of the scroll case.
